(19) United States
(12) Patent Application Publication
(10) Pub. No.: US 2009/0120510 A1
(43) Pub. Date: May 14, 2009

(54) LOCKING COVER

(76) Inventors: Edwin Evans, Irvine, CA (US); George Brown, Downey, CA (US); Louis Halper, Long Beach, CA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/938,641

(22) Filed: Nov. 12, 2007

(51) Int. Cl. F16K 35/10

(52) U.S. Cl. 137/383; 138/89; 220/252; 70/232

(57) ABSTRACT

A cover for a fluid connection that has a first positioning element and an opening. The cover includes a first portion that is positioned to cover a portion of the opening and a second portion that includes a second positioning element. The second portion is movable with respect to the first portion between a first position, in which the first positioning element and the second positioning element are engaged, and a second position, in which the first positioning element and the second positioning element are disengaged.

### BACKGROUND

The present invention relates to covers for fluid openings. More specifically, the invention relates to lockable covers for fluid openings.

Many buildings include sprinkler systems designed to extinguish and contain fires. Such systems often include fluid connections that allow fire fighters to pump water into the building or draw water from the building. Such fluid connections often include a swivel that is threaded and configured to attach to a hose. Often, these fluid connections are left for long durations without use. During these periods, the threads can become damaged or dirty, thereby making it difficult to threadably connect a hose to them.

### SUMMARY

In one construction, the invention provides a cover for a fluid connection that has a first positioning element and an opening. The cover includes a first portion that is positioned to cover a portion of the opening and a second portion that includes a second positioning element. The second portion is movable with respect to the first portion between a first position, in which the first positioning element and the second positioning element are engaged, and a second position, in which the first positioning element and the second positioning element are disengaged.

In another construction, the invention provides a cover for a fluid connection that has a first positioning element and an opening. The cover includes a face portion that defines a perimeter and covers at least a portion of the opening, a first side portion that extends along a portion of the perimeter and is fixed with respect to the face portion, a second side portion that extends along a portion of the remaining perimeter and is movable with respect to the face portion and the first side portion between an engaged position and a disengaged position, and a second positioning element that is defined as part of the second side portion and is engageable with the first positioning element when the second side portion is in the engaged position.

In yet another construction, the invention provides a cover for a fluid connection that has a first positioning element, a second positioning element, and an opening. The cover includes a face portion that defines a perimeter and is positioned to cover a portion of the opening, a first side portion is fixedly coupled to the face portion, extends along a portion of the perimeter, and defines a third positioning element, and a first locking member is coupled to the first side portion. A second side portion extends along a portion of the remaining perimeter and defines a fourth positioning element, a second locking member is coupled to the second side portion, and a joint element is positioned to movably connect the second side portion to the first side portion and to facilitate movement of the second portion between a disengaged position and an engaged position in which the first positioning element engages the third positioning element and the second positioning element engages the fourth positioning element. A locking device engages at least one of the first locking member and the second locking member to inhibit movement of the second side portion from the engaged position to the disengaged position.

Other aspects of the invention will become apparent by consideration of the detailed description and accompanying drawings.

### BRIEF DESCRIPTION OF THE DRAWINGS

FIG. 1 is a perspective view of a cover that embodies the invention and is coupled to a fluid connection.

FIG. 2 is an exploded perspective view of the cover of FIG. 1 and a swivel.

FIG. 3 is a perspective view of the cover of FIG. 1 in an open position.

FIG. 4 is a perspective view of the cover of FIG. 1 in a closed position.

FIG. 5 is a perspective view of another cover in a closed position.

FIG. 6 is a perspective view of the cover of FIG. 6 in an open position.

FIG. 7 is another perspective view of the cover of FIG. 6 in an open position.

FIG. 8 is perspective view of another cover in an open position.

### DETAILED DESCRIPTION

Before any constructions of the invention are explained in detail, it is to be understood that the invention is not limited in its application to the details of construction and the arrangement of components set forth in the following description or illustrated in the following drawings. The invention is capable of other constructions and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

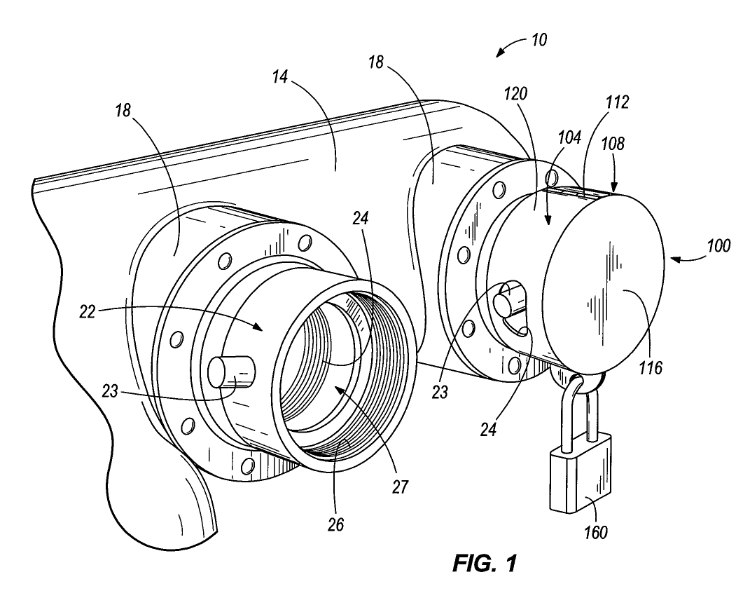

FIG. 1 illustrates a fluid connection 10 that includes a manifold 14, two connection portions 18 that are integrally-formed with the manifold 14, and one swivel 22 threaded into each of the connection portions 18. The fluid connection 10 is similar to those used in buildings to allow fire departments to connect hoses that may be used to supply additional water to a building's sprinkler system. Although the illustrated fluid connection 10 includes two connection portions 18, less than two or more than two connection portions 18 are conceivable. The connection portions 18 may additionally be welded, bolted, or otherwise fixed to the manifold 14. In addition, manifolds 14 of this type can be positioned in upper levels of tall buildings to allow fire fighters to connect hoses at the upper levels and draw water from the buildings plumbing system if desired.

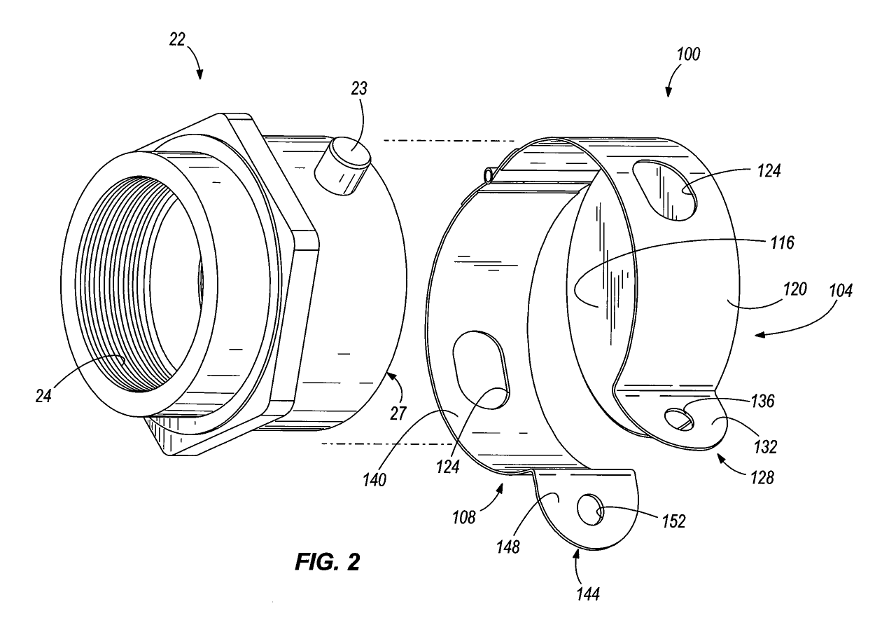

The swivels 22 typically include positioning elements such as pins 23, a manifold connection 24 (see FIG. 2) that threads onto the connection portion 18, a threaded portion 26 that is configured to receive a hose or other connection (not shown), and a fluid opening 27. The illustrated swivels 22 include two pins 23 spaced approximately 180 degrees from each other, though other arrangements with more than two pins 23 or less than two pins 23 oriented in a variety of angles and positions may be employed. It should also be noted that while the illustrated construction includes pins 23 formed as part of the swivel 22, other constructions may position the pins 23 on the manifold 14 or connection portions 18 if desired.

With continued reference to FIG. 1, a cover 100 engages the swivel 22 to cover the fluid opening 27 and a portion of the connection portion 18. Turning to FIG. 2, the cover 100 includes a first portion 104, and a second portion 108 that is coupled to the first portion 104 with a joint element such as a hinge 112. The first portion 104 includes a face portion 116 that completely covers the fluid opening 27 and defines a circular perimeter. Of course, other shapes are also possible. Additionally, face portions 116 that do not completely cover the opening 27 are also possible. For example, another construction employs a screen as the face portion 116.

A first side portion 120 extends along a portion of the perimeter and defines a positioning element such as an aperture 124. In the illustrated construction, the aperture 124 is an oval, although other shapes are also possible. Other constructions may employ pins or other positioning elements in place of or in conjunction with the aperture 124. In the illustrated construction, the first side portion 120 extends around about half of the perimeter. Of course, other constructions may include a first side portion 120 that extends around more than half the perimeter or less than half the perimeter as desired.

A first locking member 128 includes a first tab 132 that defines a first bore 136 and is attached to the first side portion 120. In the illustrated construction, the first locking member 128 is integrally formed with the first side portion 120. In other constructions the first locking member 128 may be attached to the first side portion 120 with welds, bolts, hinges, or other means. Furthermore, the first tab 132 may be other shapes as well as attached at different angles with respect to the first side portion 120.

The second portion 108 extends along a portion of the remaining perimeter and includes a second side portion 140 that defines another positioning element such as an aperture 124. Again, the aperture 124 is illustrated as an oval with other shapes being possible. The second portion 108 is movable with respect to the first portion 104 between a first or closed position (shown in FIG. 1) and a second or open position (shown in FIG. 2). The illustrated second side portion 140 extends around about half of the perimeter such that the combination of the first side portion 120 and the second side portion 140 extend around substantially the entire perimeter of the face portion 116. However, other constructions may include side portions 120, 140 that extend around more or less of the perimeter.

A second locking member 144 that includes a second tab 148 that defines a second bore 152 is attached to the second side portion 140. In the illustrated construction, the second locking member 144 is integrally formed with the second side portion 140. In other constructions the second locking member 144 may be attached to the second side portion 140 with welds, bolts, hinges, or other means. Furthermore, the second tab 148 may be other shapes as well as attached at different angles with respect to the second side portion 140.

FIGS. 1 and 4 depict the cover 100 in the closed position. In this position, the aperture 124 of the first portion 104 receives one of the pins 23 of the swivel 22 and the aperture 124 of the second portion 108 receives the other pin 23 of the swivel 22. In the closed position, the first bore 136 and the second bore 152 are substantially aligned such that a portion of a locking device such as a padlock 160 can engage both the first bore 136 and the second bore 152 and thereby inhibit movement of the cover 100 from the closed position to the open position.

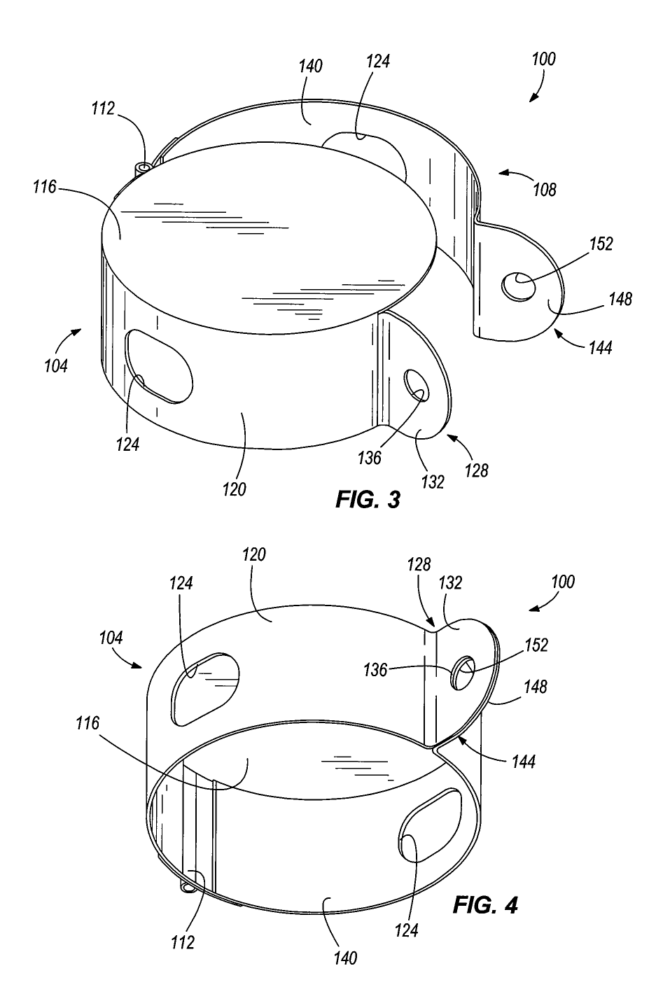

FIGS. 2 and 3 depict the cover 100 in one illustration of the open position. In this illustration of the open position, the aperture 124 of the first portion 104 is disengaged from the pins 23 of the swivel 22 and the aperture 124 of the second portion 108 is disengaged from the pins 23 of the swivel 22. In the open position, the first bore 136 and the second bore 152 are substantially misaligned and cannot receive a portion of the padlock 160 through both the first bore 136 and the second bore 152.

While still in the open position, the cover 100 is positioned on the swivel 22 such that the stationary aperture 124 of the first portion 104 is engaged with one of the pins 23 of the swivel 22. The second portion 108 is positioned such that the aperture 124 of the second portion 108 is disengaged from the other pin 23 of the swivel 22. While positioned on the swivel 22 and in the open position, the first bore 136 and the second bore 152 are substantially misaligned and cannot receive a portion of the padlock 160 through both the first bore 136 and the second bore 152.

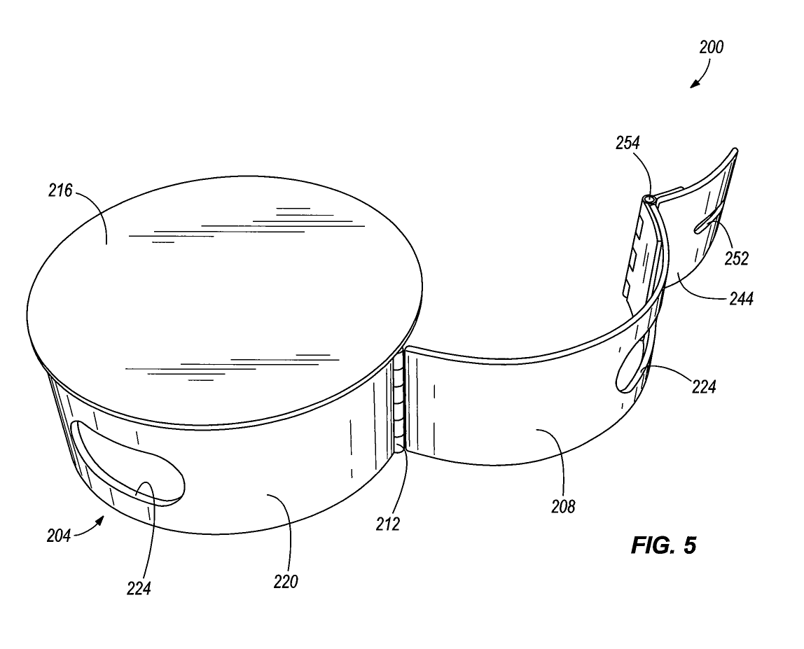

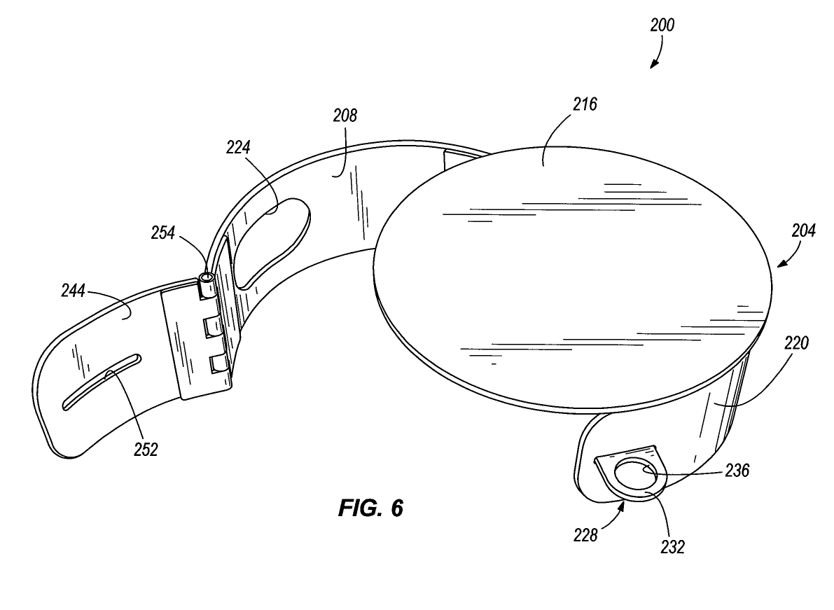

FIGS. 5-7 illustrate another cover 200 that is suitable for use in covering a fluid opening 27. The cover 200 engages the swivel 22 in a similar manner to the cover 100 in order to protect the fluid opening 27 of the swivel 22 and the connection portion 18 of the manifold 14.

With reference to FIGS. 5-7, the cover 200 includes a first portion 204, and a second side portion 208 that is coupled to the first portion 204 with a joint element such as a hinge 212. The first portion 204 includes a face portion 216 that completely covers the fluid opening 27 of the swivel 22. The face portion 216 defines a circular perimeter with other shapes being possible. Of course, face portions 216 that do not completely cover the opening 27 are also possible. For example, another construction employs a screen as the face portion 216.

The first portion 204 also includes a first side portion 220 that extends along a portion of the perimeter and defines a positioning element such as an aperture 224. In the illustrated construction, the aperture 224 is an oval, although other shapes are also possible. Other constructions may employ pins or other positioning elements in place of or in conjunction with the aperture 224. The first side portion 220 extends around about half of the perimeter. Of course, other constructions may include a first side portion 220 that extends around more than half the perimeter or less than half the perimeter as desired.

A first locking member such as a tab 232 is attached to the first side portion 220 and defines a bore 236. In the illustrated construction, the tab 232 extends normally from the surface of the first side portion 220 and is integrally formed with the first side portion 220. In other constructions, the tab 232 may be attached to the first side portion 220 by welds, fasteners, or other means. In addition, other constructions of the tab 232 may employ a different shape.

While the illustrated construction includes a tab 232 that is attached to the first side portion, other constructions may employ a tab that is formed as part of the first side portion 220 or the second side portion 208. For example, one construction stamps the first side portion 220 as a rectangular portion that is bent in an arc. A portion of the rectangular portion is then bent normal to the rectangular portion to define the tab 232.

The second side portion 208 extends along a portion of the remaining perimeter and defines another positioning element such as an aperture 224. The second side portion 208 includes a second locking member 244 that defines an aperture 252 and is coupled to the second side portion 208 with a second joint element such as a hinge 254 such that the second locking member 244 is movable with respect to the second side portion 208.

The second side portion 208 is movable with respect to the first portion 204 between a first or closed position and a second or open position. The illustrated second side portion 208 extends around about half of the perimeter such that the combination of the first side portion 220 and the second side portion 208 extend around substantially the entire perimeter of the face portion 216. However, other constructions may include side portions 220, 240 that extend around more or less of the perimeter.

FIGS. 5 and 6 depict the cover 200 in the open position in which the aperture 224 of the first portion 204 is disengaged from one of the pins 23 of the swivel 22 and the aperture 224 of the second side portion 208 is disengaged from the other pin 23 of the swivel 22. In the open position, the tab 232 and the bore 236 are not disposed within the aperture 252 so the second locking member 244 does not inhibit the movement of the cover 200 between the closed position and the open position.

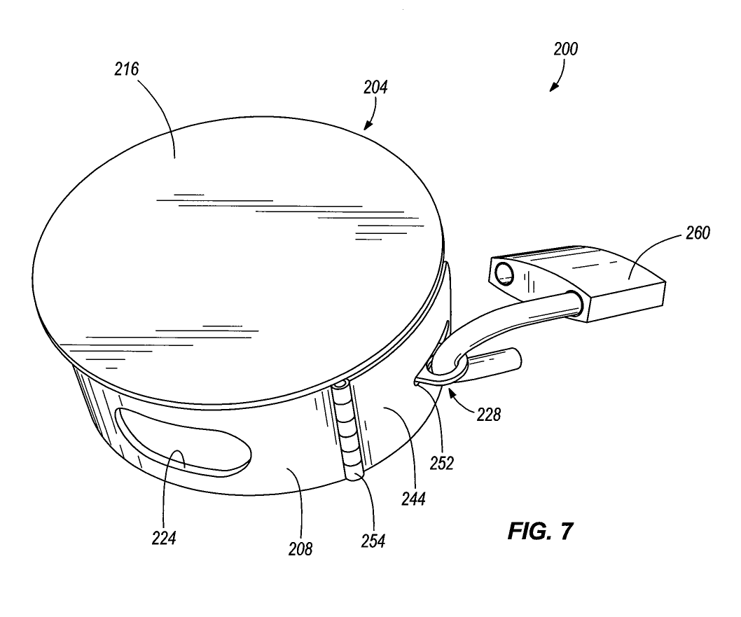

FIG. 7 depicts the cover 200 in the closed position. In this position, the aperture 224 of the first portion 204 receives one of the pins 23 of the swivel 22 and the aperture 224 of the second side portion 208 receives the other pin 23 of the swivel 22. In the closed position, the tab 232 and the bore 236 are disposed within and protrude through the aperture 252. The bore 236 receives a portion of a locking device such as a padlock 260 and thereby inhibits the cover 200 from moving from the closed position to the open position.

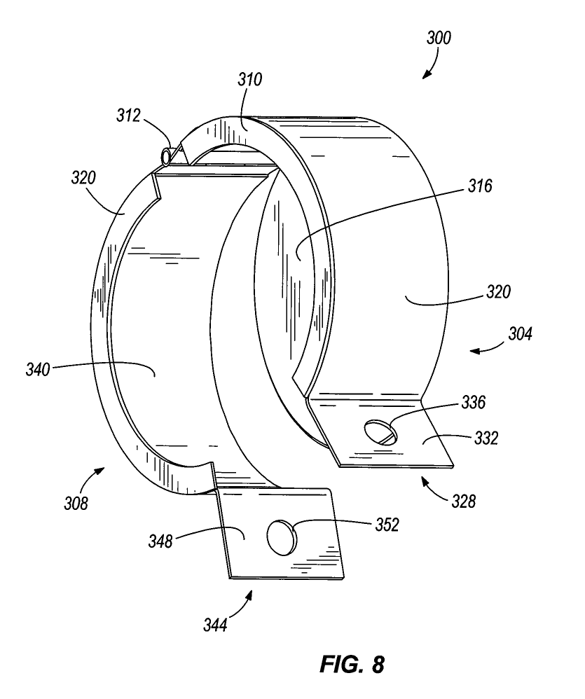

FIG. 8 illustrates another cover 300 that is suitable for use in covering a fluid opening 27. The cover 300 is similar to the cover 100 shown in FIGS. 1-4 and engages the swivel 22 in a similar manner to the cover 100 in order to protect the fluid opening 27 of the swivel 22 and the connection portion 18 of the manifold 14.

The cover 300 replaces the apertures 124 of the cover 100 shown in FIGS. 1-4 with a first protrusion 310 extending from a first side portion 320 and a second protrusion 322 extending from a second side portion 340. The first protrusion 310 and the second protrusion 322 extend from a side opposite the face portion 316 of the first side portion 320 and the second side portion 340, respectively. The illustrated first protrusion 310 and second protrusion 322 cooperate to extend substantially around a perimeter defined by the face portion 316. In other constructions, the first protrusion 310 and the second protrusion 322 may extend around less of the perimeter. In addition, the first protrusion 310 and the second protrusion 322 may include multiple protrusions spaced along the perimeter.

The swivel 22 receives the first protrusion 310 and the second protrusion 322 such that the cover 300 is inhibited from inadvertent removal from the swivel 22.

It should be understood that while the face portion 116, 216, 316 has been illustrated as a solid cover, other constructions could employ a partial cover, a screen, or other cover type. In addition, the joint element 112, 212, 312 is illustrated as a hinge though it could be removed or replaced with another joint element such as a living hinge, or other joint element. Furthermore, the locking device may be a padlock 106, 260 or any other locking device.

In operation, the cover 100 is held by a user in the open position away from the fluid connection 10 such that the aperture 124 of the first portion 104 is disengaged from the pins 23 of the swivel 22 and the aperture 124 of the second portion 108 is disengaged from the pins 23 of the swivel 22.

Then, while still in the open position, the cover 100 is positioned over the fluid opening 27 such that the aperture 124 of the first portion 104 is engaged with one of the pins 23 of the swivel 22. The second portion 108 is positioned such that the aperture 124 of the second portion 108 is disengaged from the other pin 23 of the swivel 22.

To move the cover 100 into the close position, the second portion 108 is pivoted about the hinge 112 into the closed position such that the aperture 124 of the second portion 108 receives the other pin 23 of the swivel 22. In the closed position, the first bore 136 and the second bore 152 substantially aligned such that a portion of the padlock 160 engages both the first bore 136 and the second bore 152 and inhibit movement of the cover 100 from the closed position to the open position.

To remove the cover 100 from the fluid connection 10, the padlock is disengaged from the first bore 136 and the second bore 152. The second portion 108 is pivoted into the open position wherein the aperture 124 of the second portion 108 is disengaged from the pin 23 of the swivel 22. The cover 100 is then removed from the fluid connection such that the aperture 124 of the first portion 104 is disengaged from the pins 23 of the swivel 22 and the aperture 124 of the second portion 108 is disengaged from the pins 23 of the swivel 22.

When the cover 100 is removed, access is provided to the swivel 22 for connection of the hose or other connection.

Cover 200 operates in a manner similar to that of cover 100. The cover 200 is held away from the fluid connection 10 with the aperture 224 of the first portion 204 disengaged from the pins 23 of the swivel 22 and the aperture 224 of the second side portion 208 is disengaged from the other pin 23 of the swivel 22.

The cover 200 is then positioned over the fluid opening 27 while still in the open position such that the aperture 224 of the first portion 204 is engaged with one of the pins 23 of the swivel 22. The second side portion 208 is positioned such that the aperture 224 of the second side portion 208 is disengaged from the other pin 23 of the swivel 22.

The second side portion 208 is then moved into the closed position wherein the aperture 224 of the first portion 204 is engaged with one of the pins 23 of the swivel 22 and the aperture 224 of the second side portion 208 is engaged with the other pin 23 of the swivel. The second locking member 244 is then pivoted about hinge 254 such that the tab 232 is disposed within the aperture 252. A portion of a padlock 260 is then engaged through the bore 236 so as to inhibit the tab 232 from exiting the aperture 252, thereby inhibiting the removal of the cover 200 from the fluid connection 10.

To remove the cover 200 from the fluid connection 10, the padlock 260 is removed, and the second locking member 244 and the second side portion 208 are pivoted to the open position such that the tab 232 is not disposed within the aperture 252 of the second locking member 244 and the pin 23 is disengaged from the aperture 224 of the second side portion 208. The cover 200 is then removed from the fluid connection 10 such that the aperture 224 of the first portion 204 is disengaged from the pins 23 of the swivel 22 and the aperture 224 of the second side portion 208 is disengaged from the other pin 23 of the swivel 22.

When the cover 200 is removed, access is provided to the swivel 22 for connection of the hose or other connection.

Thus, the invention provides, among other things, a cover for a fluid opening. Various features and advantages of the invention are set forth in the following claims.

1. A cover for a fluid connection having a first positioning element and an opening, the cover comprising:
a first portion positioned to cover a portion of the opening; and
a second portion including a second positioning element, the second portion movable with respect to the first portion between a first position in which the first positioning element and the second positioning element are engaged and a second position in which the first positioning element and the second positioning element are disengaged.

2. The cover of claim 1, further comprising a joint element positioned to interconnect the first portion and the second portion.

3. The cover of claim 1, further comprising a first locking member, connected to the first portion and a second locking member connected to the second portion.

4. The cover of claim 3, further comprising a locking device connected to the first locking member and the second locking member.

5. The cover of claim 4, wherein the first locking member includes a first tab and a first bore, and the second locking member includes a second tab and a second bore, the first bore and the second bore being substantially aligned with one another when the second portion is in the first position.

6. The cover of claim 5, wherein the first bore and the second bore are configured to receive a portion of the locking device.

7. The cover of claim 1, wherein the fluid connection includes a third positioning element, and wherein the first portion defines a fourth positioning element that engages the third positioning element when the second portion is in the first position.

8. The cover of claim 1, wherein one of the first positioning element and the second positioning element is a pin and the other is an aperture configured to receive the pin.

9. A cover for a fluid connection having a first positioning element and an opening, the cover comprising:
a face portion defining a perimeter and covering at least a portion of the opening;
a first side portion extending along a portion of the perimeter and fixed with respect to the face portion;
a second side portion extending along a portion of the remaining perimeter and movable with respect to the face portion and the first side portion between an engaged position and a disengaged position; and
a second positioning element defined as part of the second side portion and engageable with the first positioning element when the second side portion is in the engaged position.

10. The cover of claim 9, further comprising a first locking member connected to the first side portion, and a second locking member connected to the second side portion.

11. The cover of claim 10, wherein the first locking member includes a first tab and a first bore, and the second locking member includes a second tab and a second bore, the first bore and the second bore being substantially aligned with one another when the second portion is in the engaged position.

12. The cover of claim 10, further comprising a locking device connected to at least one of the first locking member and the second locking member to inhibit movement from the engaged position to the disengaged position.

13. The cover of claim 9, further comprising a joint element positioned to interconnect the first side portion and the second side portion.

14. The cover of claim 9, wherein the fluid connection includes a third positioning element, and at least one of the top portion, the first portion, and the second portion defines a fourth positioning element that engages with the third positioning element when the second side portion is in the engaged position.

15. The cover of claim 9, wherein one of the first positioning element and the second positioning element is a pin and the other is an aperture configured to receive the pin.

16. The cover of claim 9, wherein the second side portion includes a first movable portion and a second movable portion, the first movable portion movable with respect to the first side portion and the second movable portion, and the second movable portion movable with respect to the first movable portion and the first side portion.

17. The cover of claim 16, further comprising a first hinge that connects the first movable portion to the first side portion, and a second hinge that connects the first movable portion to the second movable portion.

18. A cover for a fluid connection having a first positioning element, a second positioning element, and an opening, the cover comprising:
a face portion defining a perimeter and positioned to cover a portion of the opening;
a first side portion fixedly coupled to the face portion and extending along a portion of the perimeter, the first side portion defining a third positioning element;
a first locking member coupled to the first side portion;
a second side portion extending along a portion of the remaining perimeter, the second side portion defining a fourth positioning element;
a second locking member coupled to the second side portion;
a joint element positioned to movably connect the second side portion to the first side portion to facilitate movement of the second portion between a disengaged position and an engaged position in which the first positioning element engages the third positioning element and the second positioning element engages the fourth positioning element; and
a locking device that engages at least one of the first locking member and the second locking member to inhibit movement of the second side portion from the engaged position to the disengaged position.

19. The cover of claim 18, wherein the first locking member includes a first tab and a first bore, and the second locking member includes a second tab and a second bore, the first bore and the second bore being substantially aligned with one another when the second portion is in the engaged position.

20. The cover of claim 18, wherein one of the first positioning element and the third positioning element is a pin and the other is an aperture configured to receive the pin.

21. The cover of claim 18, wherein the combination of the first side portion and the second side portion extend around substantially the entire perimeter.

22. The cover of claim 19, wherein the first tab and the second tab are formed as one piece with the first side portion and the second side portion respectively.

23. The cover of claim 18, wherein the first locking member includes a tab and an aperture, and the second locking member includes a slot sized to receive the tab.

24. The cover of claim 18, wherein the second side portion includes a first movable portion and a second movable portion, the first movable portion movable with respect to the first side portion and the second movable portion, and the second movable portion movable with respect to the first movable portion and the first side portion.

25. The cover of claim 24, further comprising a first hinge that connects the first movable portion to the first side portion, and a second hinge that connects the first movable portion to the second movable portion.

26. A cover for a fluid connection having a first positioning element and an opening, the cover comprising:
a first portion including a face portion that selectively covers the opening, and a first locking member, the first portion selectively coupled to the fluid connection and selectively lockable to inhibit de-coupling of the first portion and the fluid connection;
a second portion including a side portion that defines a second positioning element that selectively engages the first positioning element of the fluid connection; and
a joint element connecting the first portion and the second portion such that the second portion moves relative to the first portion.

27. The cover of claim 26, wherein the first positioning element is on of a pin and an aperture, and the second positioning element is the other of the pin and the aperture.

28. The cover of claim 26, further comprising a third positioning element coupled to the fluid connection and a fourth positioning element coupled to the second portion, and wherein the first positioning element and the third positioning element are pins and the second positioning element and the fourth positioning element are apertures.

29. The cover of claim 26, wherein the second portion rotates relative to the first portion.
